(19) United States
(12) Patent Application Publication
(10) Pub. No.: US 2008/0255925 A1
(43) Pub. Date: Oct. 16, 2008

(54) SYSTEMS AND METHODS FOR GENERATING VALUE-BASED INFORMATION

(76) Inventors: Aditya Vailaya, San Jose, CA (US); Jiang Wu, Union City, CA (US)

Correspondence Address: Zilka-Kotab, PC, P.O. BOX 721120, SAN JOSE, CA, 95172-1120, US

(21) Appl. No.: 11/963,684

(22) Filed: Dec. 21, 2007

Related U.S. Application Data
(60) Provisional application No. 60/912,108, filed on Apr. 16, 2007.

(51) Int. Cl. G06Q 30/00

(52) U.S. Cl. 705/10

(57) ABSTRACT

Methods for generating value-based information are presented. Methods for displaying product information are also presented. In one approach, a feature to price distribution is approximated for each of a plurality of features of a plurality of products. Additionally, a product feature score is computed for each of at least a subset of the products. Furthermore, data corresponding to a visual representation of the at least a subset of the products in relation to each other is output based on the product feature scores and prices of each of the at least a subset of the products. In another approach, a value is assigned to each of a plurality of features of a plurality of products. Additionally, a product feature score is computed for each of at least a subset of the products. Furthermore, data corresponding to a visual representation of the at least a subset of the products in relation to each other is output based on the product feature scores and prices of each of the at least a subset of the products.

### RELATED APPLICATIONS

The present application claims priority from U.S. Provisional Patent Application filed Apr. 16, 2007 under Ser. No. 60/912,108, which is incorporated herein by reference in its entirety.

### FIELD OF THE INVENTION

The present invention relates to displaying information, and more particularly to displaying product information.

### BACKGROUND

Many times, today's product information presentations fall into two categories: simple and detailed. In the simple category, a user is typically given a product image, short description, and price. In the detailed category, the user is often presented with an overabundance of reviews, specs, and discussions to read. However, the simple information is not enough to give the user a sense as to what the product is about, and the detailed information may simply be too much for the user to take in, particularly where the user is researching multiple products. Various services have started adding other summarized information to address this. For example, numerical ratings from experts or users are added to the simple information. While these address the issues of user opinion, they do not provide a way to display product facts in a simple presentation.

There is thus a need for addressing these and/or other issues associated with the prior art.

### SUMMARY

A method is provided for generating value-based information. In use, statistical data is generated for particular features of a plurality of products based on prices of the products. Additionally, a base score for each of the features is generated based on the statistical data. Further, for each of at least some of the products, a product feature score is computed for the product based on the base scores of the features that the product has. Further still, for the at least some of the products, a representation of a value of each of the at least some of the products in relation to each other is output, where the representation of the value is based on the product feature score and the price for each of the products.

In another embodiment, a method is provided for displaying product information. In use, a feature to price distribution is approximated for each of a plurality of features of a plurality of products. Additionally, a product feature score is calculated for each of at least a subset of the products. Furthermore, data corresponding to a visual representation of the at least a subset of the products in relation to each other is output based on the product feature scores and prices of each of the at least a subset of the products.

In yet another embodiment, a method is provided for displaying product information, in accordance with another embodiment. In use, a value is assigned to each of a plurality of features of a plurality of products. Additionally, a product feature score is calculated for each of at least a subset of the products. Furthermore, data corresponding to a visual representation of the at least a subset of the products in relation to each other is output based on the product feature scores and prices of each of the at least a subset of the products.

Further still, a method is provided for displaying product information, in accordance with yet another embodiment. In use, a value of each of a plurality of products relative to the other products is determined, where the values are based on features and prices of the products. Additionally, data corresponding to a visual representation of the products in relation to each other is output based on the value of the products in relation to each other.

Additionally, a method is provided for displaying product information, in accordance with still yet another embodiment. In use, under control of a computer, a value of each of a plurality of products relative to the other products is determined, where the values are based on features and prices of the products. Additionally, data corresponding to a visual representation of the products in relation to each other is output on a plot of features vs. product price based on the value of the products in relation to each other. Further, user input specifying a subset of the products is received, and data corresponding to a visual representation of the subset of products is output. Further still, for at least one of the products, data corresponding to an additional visual representation listing a select number of the features of the product is output, and data corresponding to a link to additional information about the product is output, wherein a subset of the visual representations are highlighted based on defined criteria.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1 illustrates a network architecture, in accordance with one embodiment.

FIG. 2 shows a representative hardware environment that may be associated with the servers and/or clients of FIG. 1, in accordance with one embodiment.

FIG. 3 shows a method for generating value-based information, in accordance with one embodiment.

FIG. 4 a method for displaying product information, in accordance with another embodiment.

FIG. 5 shows a method for displaying product information, in accordance with yet another embodiment.

FIG. 6 shows a method for displaying product information, in accordance with still another embodiment.

FIG. 7 shows a method for displaying product information, in accordance with still yet another embodiment.

FIG. 8 shows an exemplary embodiment of a box diagram, in accordance with one another embodiment.

FIG. 9 shows a “baseline” feature level graph, in accordance with one embodiment.

FIG. 10 shows a “baseline” feature level graph with overlap, in accordance with one embodiment.

FIG. 11 shows an example of a graph of a feature with a large standard deviation, in accordance with one embodiment.

FIG. 12 shows an example of a graph of a feature with a small standard deviation, in accordance with one embodiment.

FIG. 13 shows a feature-price chart, in accordance with one embodiment.

FIG. 14 shows an analysis of the significance of product location on a feature-price chart, in accordance with one embodiment.

FIG. 15 shows a second display which may accompany a feature-price chart, in accordance with one embodiment.

FIG. 16 shows a description including a simple list, in accordance with one embodiment.

FIG. 17 shows a product snapshot, in accordance with another embodiment.

FIG. 18 shows a product snapshot manufacturer grouping, in accordance with one embodiment.

FIG. 19 shows an example of filtering by attributes, in accordance with one embodiment.

FIG. 20 shows an example of drilling down, in accordance with one embodiment.

FIG. 21 shows an example of advanced product navigation, in accordance with one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

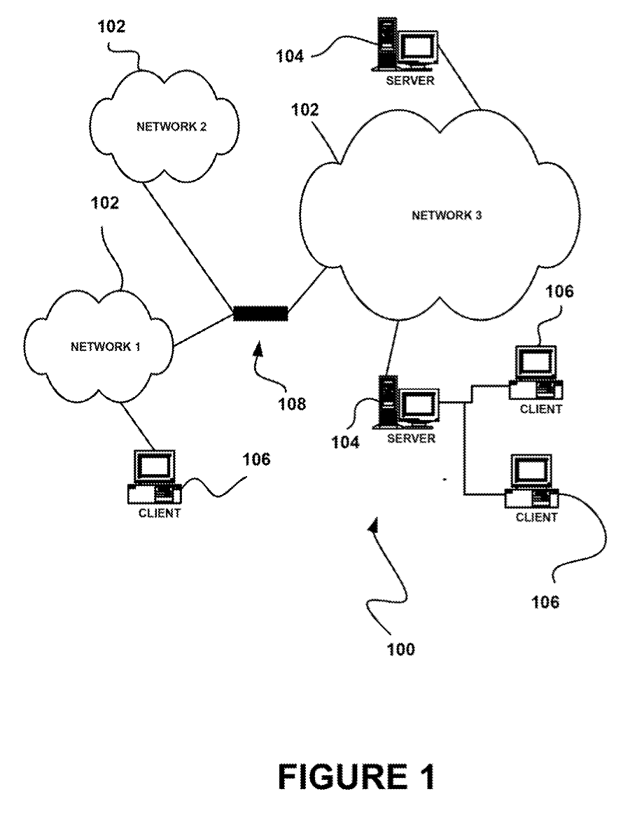

FIG. 1 illustrates a network architecture 100, in accordance with one embodiment. As shown, a plurality of networks 102 is provided. In the context of the present network architecture 100, the networks 102 may each take any form including, but not limited to a local area network (LAN), a wireless network, a wide area network (WAN) such as the Internet, peer-to-peer network, etc.

Coupled to the networks 102 are servers 104 which are capable of communicating over the networks 102. Also coupled to the networks 102 and the servers 104 is a plurality of clients 106. Such servers 104 and/or clients 106 may each include a desktop computer, lap-top computer, hand-held computer, mobile phone, smart phone and other types of mobile media devices (with or without telephone capability), personal digital assistant (PDA), peripheral (e.g. printer, etc.), any component of a computer, and/or any other type of logic. In order to facilitate communication among the networks 102, at least one gateway 108 is optionally coupled therebetween.

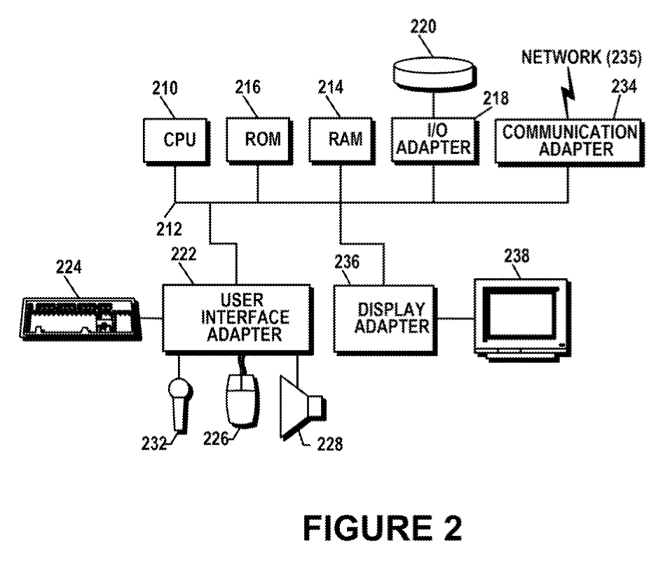

FIG. 2 shows a representative hardware environment that may be associated with the servers 104 and/or clients 106 of FIG. 1, in accordance with one embodiment. Such figure illustrates a typical hardware configuration of a workstation in accordance with one embodiment having a central processing unit 210, such as a microprocessor, and a number of other units inter connected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen (not shown) to the bus 212, communication adapter 234 for connecting the workstation to a communication network 235 (e.g., a data processing network) and a display adapter 236 for connecting the bus 212 to a display device 238.

The workstation may have resident thereon any desired operating system. It wilt be appreciated that an embodiment may also be implemented on platforms and operating systems other than those mentioned. One embodiment may be written using JAVA, C, and/or C++ language, or other programming languages, along with an object oriented programming methodology. Object oriented programming (OOP) has become increasingly used to develop complex applications.

Of course, the various embodiments set forth herein may be implemented utilizing hardware, software, or any desired combination thereof. For that matter, any type of logic may be utilized which is capable of implementing the various functionality set forth herein.

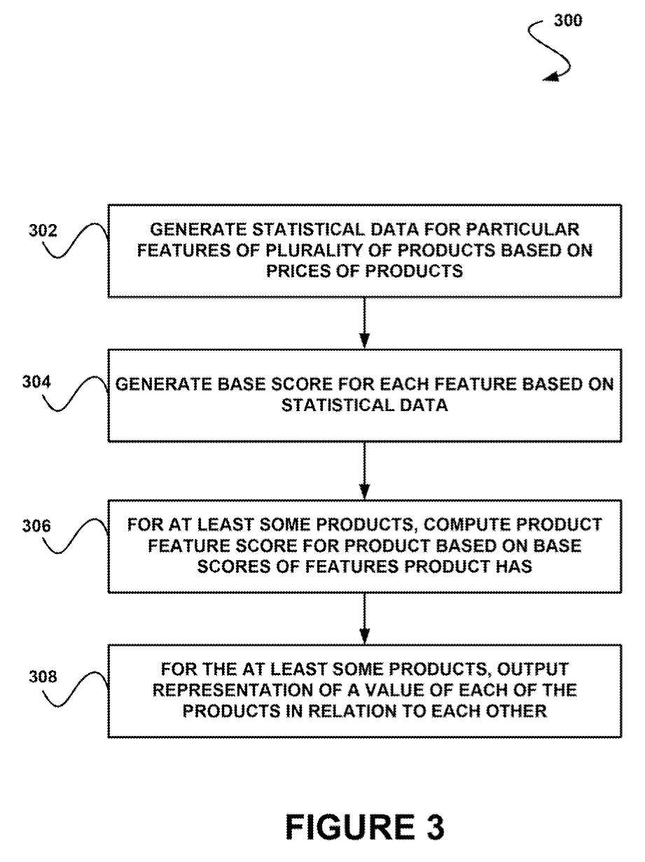

FIG. 3 shows a method 300 for generating value-based information, in accordance with one embodiment. As an option, the method 300 may be carried out in the context of the architecture and environment of FIGS. 1 and/or 2. Of course, however, the method 300 may be carried out in any desired environment.

As shown in operation 302, under control of a computer and/or manually, statistical data is generated for particular features of a plurality of products based on prices of the products. Additionally, in operation 304 a base score for each of the features is generated based on the statistical data.

Further, in operation 306, for each of at least some of the products, a product feature score is computed for the product based on the base scores of the features that the product has. Further still, in operation 308, for the at least some of the products, a representation of a value of each of the at least some of the products in relation to each other is output, where the representation of the value is based on the product feature score and the price for each of the products.

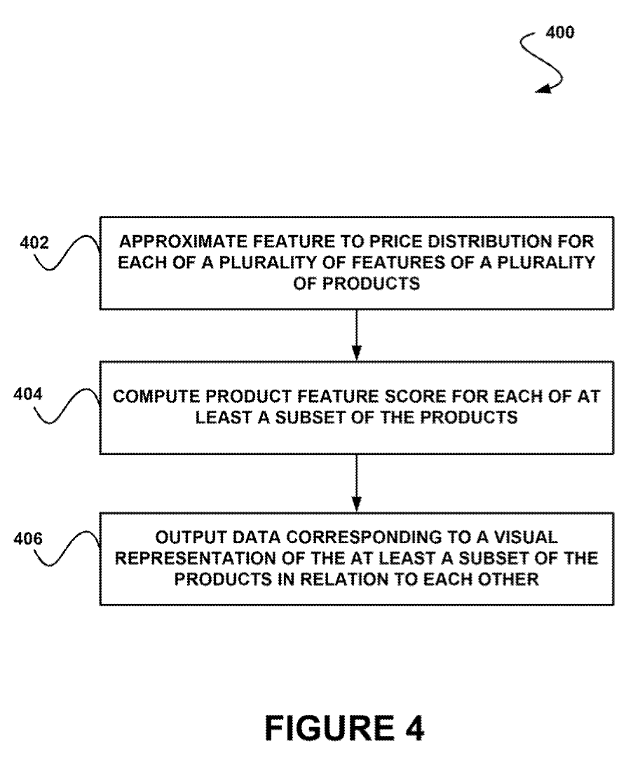

FIG. 4 illustrates a method 400 for displaying product information, in accordance with one embodiment. As an option, the method 400 may be implemented in the context of the architecture and environment of FIGS. 1-3. Of course, however, the method 400 may be implemented in any desired environment. Yet again, it should be noted that the aforementioned definitions may apply during the present description.

As shown in operation 402, a feature to price distribution is approximated for each of a plurality of features of a plurality of products. Additionally, in operation 404, a product feature score is computed for each of at least a subset of the products.

Further, in operation 406 data corresponding to a visual representation of the at least a subset of the products in relation to each other is output based on the product feature scores and prices of each of the at least a subset of the products.

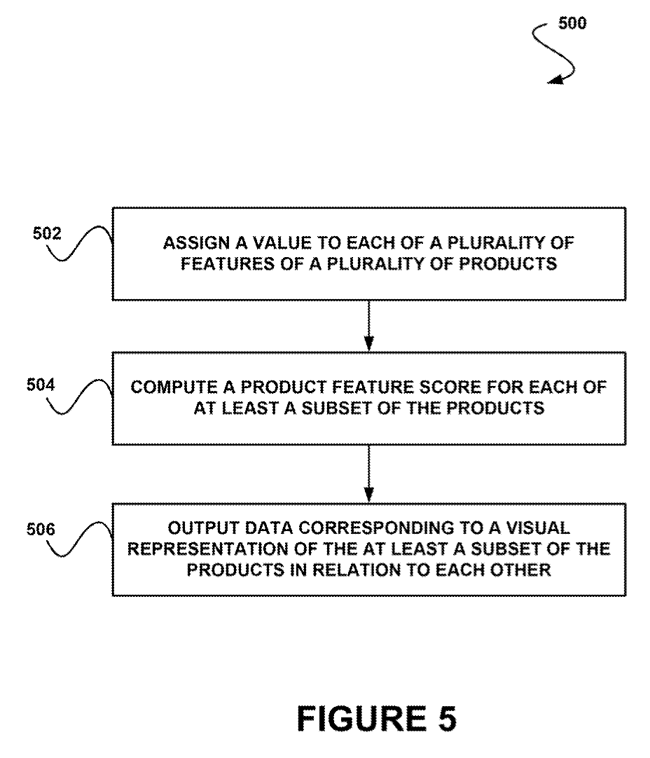

FIG. 5 illustrates a method 500 for displaying product information, in accordance with another embodiment. As an option, the method 500 may be implemented in the context of the architecture and environment of FIGS. 1-4. Of course, however, the method 500 may be implemented in any desired environment. Yet again, it should be noted that the aforementioned definitions may apply during the present description.

As shown in operation 502, a value is assigned to each of a plurality of features of a plurality of products. Additionally, in operation 504 a product feature score is computed for each of at least a subset of the products.

Further, in operation 506 data corresponding to a visual representation of the at least a subset of the products in relation to each other is output based on the product feature scores and prices of each of the at least a subset of the products.

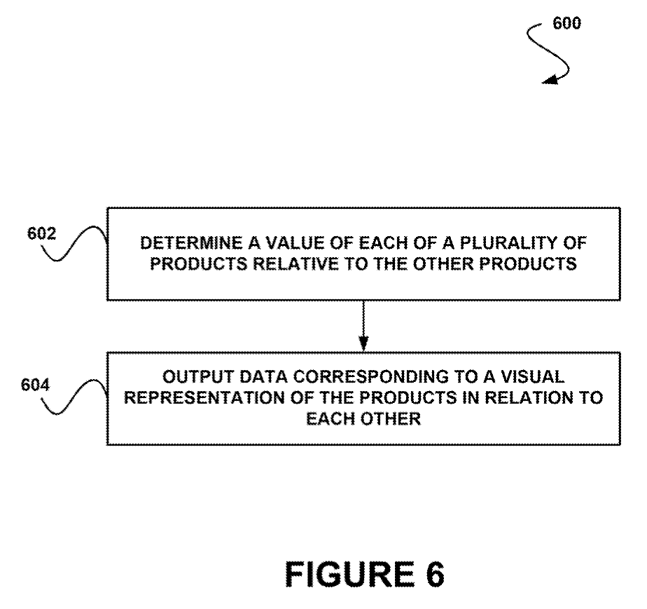

FIG. 6 illustrates a method 600 for displaying product information, in accordance with yet another embodiment. As an option, the method 600 may be implemented in the context of the architecture and environment of FIGS. 1-5. Of course, however, the method 600 may be implemented in any desired environment. Yet again, it should be noted that the aforementioned definitions may apply during the present description.

As shown in operation 602, a value of each of a plurality of products relative to the other products is determined, where the values are based on features and prices of the products. Further, in operation 604 data corresponding to a visual representation of the products in relation to each other is output based on the value of the products in relation to each other.

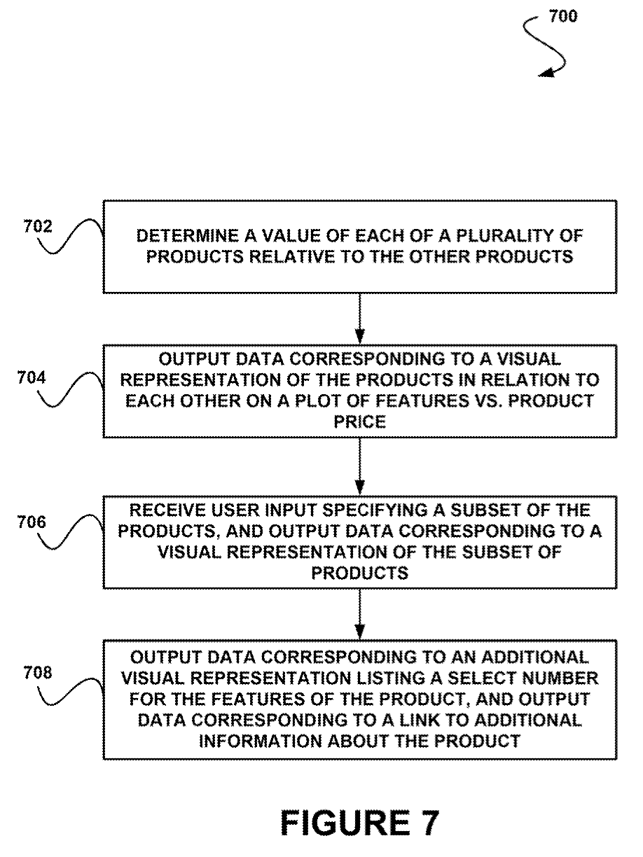

FIG. 7 illustrates a method 700 for displaying product information, in accordance with still yet another embodiment. As an option, the method 700 may be implemented in the context of the architecture and environment of FIGS. 1-6. Of course, however, the method 700 may be implemented in any desired environment. Yet again, it should be noted that the aforementioned definitions may apply during the present description.

As shown in operation 702, under control of a computer, a value of each of a plurality of products relative to the other products is determined, where the values are based on features and prices of the products.

Additionally, in operation 704, data corresponding to a visual representation of the products in relation to each other is output on a plot of features vs. product price based on the value of the products in relation to each other. Further, in operation 706, user input specifying a subset of the products is received, and data corresponding to a visual representation of the subset of products is output.

Further still, in operation 708, for at least one of the products, data corresponding to an additional visual representation listing a select number of the features of the product is output, and data corresponding to a link to additional information about the product is output, wherein a subset of the visual representations are highlighted based on defined criteria.

In the context of the present description, statistical data may include any data that is statistical in nature or based on statistical data of any type. In one embodiment, statistical data may include value data. In another embodiment, statistical data may be plotted on a graph. For example, the statistical data may be represented as a function of the number of products containing the feature vs. the price of the product containing the feature. Further, the plurality of products may include any product available for purchase by a customer. For example, the products may include automobiles, televisions, insurance, etc.

Additionally, the features of the plurality of products may include any features of the product. For example, if the product is a television, the features of the product may include screen size, screen resolution, weight, etc. In another example, if the product is a refrigerator, the features of the product may include size, efficiency, color, etc. In another embodiment, features may include not only physical or operational features of the products, but also intangibles such as manufacturer, market buzz, e.g. as reflected in commercial publications/web pages, prestige, estimated reliability, etc. Furthermore, the price of the products may include any monetary value for which the product may be sold.

In still another embodiment, generating the statistical data may include, for a particular product feature, associating each of the products with at least one of a plurality of price bins based on an actual price of the product; and, for each price bin, determining a number of products having the particular product feature.

In yet another embodiment, generating the statistical data and/or approximating the feature to price distribution may include, for a particular product feature, selecting a plurality of price bins; and, for each price bin, determining a number of products in each price bin having the particular product feature.

In another embodiment, generating the base score for each of the features based on die statistical data may include using the statistical data itself. For example, generating the base score may include determining a mean of the statistical data. In another example, generating the base score may include determining a standard deviation of the statistical data. In still another example, generating the base score for each of the features based on the statistical data may include using the mean and the standard deviation of the statistical data.

In yet another embodiment, the base score may include a monetary value. In still another embodiment, computing the product feature score may include summing the base scores of the features that the particular product has. Additionally, in one embodiment, each of the base scores may be given a weighting prior to the summing. Further, in another embodiment, the weighting may be based on at least one of a standard deviation of a feature to price distribution for each of the features of the products, a manually-defined value, and a statistically computed value based at least in part on prices of the products. Further, in one embodiment the product feature score may include a final feature for the product.

In another embodiment, computing the product feature score for a particular one of the products may include summing statistical derivatives of the feature to price distributions of the features of the particular product. Additionally, in another embodiment, each of the statistical derivatives may be given a weighting. In yet another embodiment, the weighing may be based on at least one of a standard deviation of the feature to price distribution, a manually-defined value, and a statistically computed value.

In still another embodiment, the representation of the value of each of the at least some of the products in relation to each other may include display data. In another example, the representation of the value of each of the at least some of the products in relation to each other may include data for use by another process which may ultimately output something based on the data. In yet another example, the representations of the values of the at least some of the products in relation to each other may be plotted on a chart of price vs. features.

Additionally, determining a value of each of the plurality of products relative to the other products may include computing the values as set forth herein. In another embodiment, the value can be simply retrieved or received from a database or third party. Of course, however, any portions and/or combinations of the above techniques may be used in obtaining the values.

In yet another embodiment, the data corresponding to a visual representation of the products in relation to each other based on the value of the products in relation to each other may be raw display data, data for transmission to a remote computer (e.g., HTML, XML, etc.), or any other type of data that can be manipulated or converted for display.

In one embodiment, various embodiments of the present invention may be referred to individually and collectively as “product snapshots”, which relate to the visual presentation of product information. One goal of the product snapshot is to quickly give the user a high-level understanding of a product to which the snapshot relates.

Additionally, product snapshots include visual methods of presenting key facts surrounding a product. This information may be objective.

Use Cases

A product snapshot may be useful in many cases. For example, a user may want to know what kind of product they are searching for before spending more time researching it. In another example, a user may encounter a deal for a product, and may want to obtain a quick understanding of that product to better evaluate the deal. In still another example, a summary may be syndicated to a partner's product page in order to complement it.

In still another example, it may be desirable to perform product comparisons. Also, when a user comes in for product details such as looking for a manual, the product snapshot has a visual impact that catches the user's attention making him/her want to do more at the location of the product snapshot.

Further still, in another example, a user may want to learn about most or all of a particular group of products in a quick and efficient manner. In addition, it may be desirable to utilize the product snapshot as a method of navigating from a category to products of interest.

Preferred Functionality

In one embodiment, the product snapshot may be easy to understand. For example, the product snapshot may be presented in a simple manner. In another example, the product snapshot may enable a user to view the product snapshot and immediately view the price vs. features of a product, enabling the user to determine whether the product is high value.

In another embodiment, the product snapshot may provide the user with minimal text relative to the known total amount of product information. In this way, users of the product snapshot are not overwhelmed, as more information may be available to the user that is hidden at the primary viewing level but that can be viewed at another level.

In still another embodiment, the product snapshot may be standardized across ail products and product categories. In this way, a consistent look and presentation may be maintained.

In yet another embodiment, the product snapshot may be versatile in that the same methodology and presentation may work for any subset of products. For example, a product snapshot may be presented for a category, a subset of categories, different categories, etc.

Design

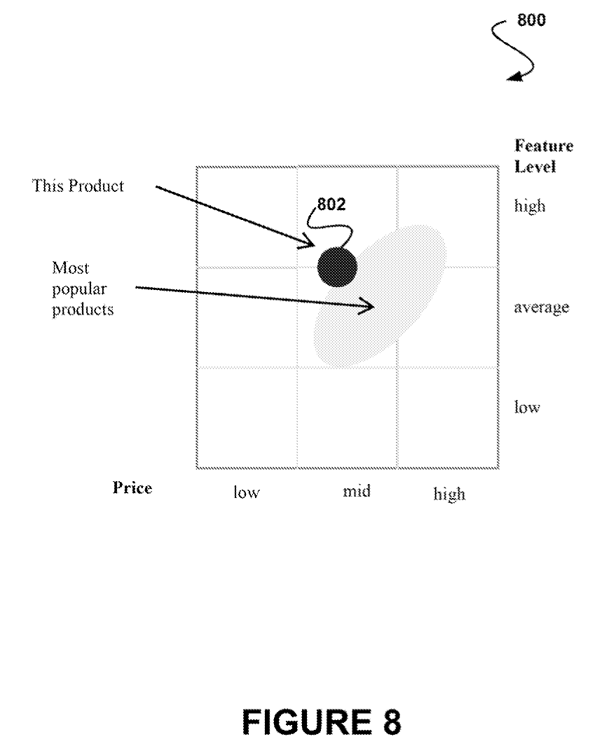

One exemplary embodiment is illustrated in FIG. 8. In use, one or more product facts, product features, etc. are chosen to be presented using a box diagram 800. Box diagram 800 displays four dimensions of information.

For example, the first dimension (y-axis) displayed by the box diagram 800 includes the relative feature level of the product 802. Additionally, the second dimension (x-axis) displayed by the box diagram 800 includes the relative price level of the product 800.

Further, the third dimension displayed by the box diagram 800 includes the popularity level of the product 802, which may be illustrated by the size of an icon representing the product 802. In one embodiment, the popularity level of the product 802 may be determined from other sites.

In another embodiment, the popularity level of the product 802 may be illustrated by an element other than the size of the icon representing the product 802. For example, a subset of the visual representations may be highlighted based on defined criteria. The highlighting may include using a different color text, a different icon type, a different icon or text size, etc. Additionally, the criteria may include such criteria as most popular item, items currently being co-displayed on the user interface, an item selected by a user, best value, etc. For example, the popularity level of the product 802 may be illustrated by the color of the icon, the shape of the icon, whether the icon is flashing or not, etc.

In another embodiment, one or more additional elements may be incorporated into the appearance of the icon representing the product 802 in the box diagram 800. For example, the icon may be sponsored by a third party, and may include a logo or advertisement provided by the third party. In another example, the icon may visually indicate whether the product 802 is currently on sale. In one embodiment, the information used to determine whether to visually indicate that the product 802 is on sale may be determined by researching one or more online resources utilizing a web crawler or other means. Of course, however, any variety of visual elements may be incorporated into the appearance of the icon representing the product 802.

Further still, the fourth dimension displayed by the box diagram 800 includes the feature/price of the product 802 relative to other popular products in this category. For example, this may be shown by the location and/or coordinates of the icon representing the product 802 in the box diagram 800 relative to icons of other popular products in this category. In one embodiment, the position of the icon may be continuously updated. In another embodiment, the position of the icon may be updated at regularly scheduled intervals. Of course, however, the position of the icon may be updated in any manner. In this way, the position of the icon may always be relative to current statistical information regarding the product 802.

In another example, if a deal (e.g., special price or offer) is found on the product 802, the icon may be moved to a different location on the box diagram 800 and the icon may additionally be highlighted. This may provide superior visual indicators with respect to the deal over a static product listing.

The exact naming of the various dimensions illustrated above may be defined in any manner. For example, the dimension illustrating the features of the product may be labeled “product type” and may include such categories as “low-end”, “mid-range”, and “high-end”.

In addition, the box diagram 800 may be accompanied by a second diagram containing detailed information about the product 802. For example, the second diagram may include a summary of the features of the product 802, a price of the product 802, other product facts for the product 802, etc.

Furthermore, in another embodiment, additional information may be incorporated into the box diagram 800. For example, a plurality of icons representing additional products may be placed in the box diagram 800 to illustrate where all products are for a category. In another example, a plurality of icons representing one or more manufacturers may be placed in the box diagram 800 to show who makes what type of product.

In still another example, a plurality of icons representing one or more stores may be placed in the box diagram 800 to show who carries high-end vs. low-end products. In yet another example, one or more portions of the box diagram 800 may be sponsored. In another example, one or more icons may be added to the box diagram 800 that indicate deals on related products available that day (e.g. “daily deals”).

In still another embodiment, the information displayed in the box diagram 800 may be filtered. For example, the filtering may display only icons for products manufactured by a particular manufacturer. In another example, the filtering may display only icons for products that are sponsored.

In yet another embodiment, one or more visual indicators may appear when a user interacts with the box diagram 800. For example, one or more pop-ups may appear when the user hovers over the icon representing the product 802. In another embodiment, one or more pop-ups may appear when the user clicks on the icon representing the product 802. Of course, however, the visual indicators may appear when a user interacts in any manner with any element of the box diagram 800.

Moreover, the price and feature level criteria used in the box diagram 800 may be used as anchoring dimensions for the incorporation of additional information in the aforementioned embodiments.

Process to Create Product Type and Price Ranges

The box diagram 800 in FIG. 8 is a summarized piece of information regarding a particular feature for a variety of products within a category. In one embodiment, price information, popularity information, or other feature information may be obtained and/or extracted from one or more sources. For example, the price and popularity information may be provided by a third party source, one or more partners, one or more web crawlers, manual data entry, etc.

In one embodiment, the features may include Boolean data (e.g., whether the product has a particular feature), range data (e.g. megapixel size of a digital camera, screen size of a television, etc.).

Once one or more features have been extracted from the products within the category, weight may be given to each individual feature element, based on a comparison with a global universe of products in the category in which the feature is located, and the prices of the products that have the feature.

Probability Distribution of a Feature Based on Price

The probability distribution of a given feature with respect to price may be approximated by dividing the price range into a large number of intervals. These intervals may be selected uniformly, non-uniformly, based on some statistical distribution, etc. For example, the products may be arranged by price, and an interval may be selected at every fifty dollar price increase. In another example, the products may be arranged by price, and an interval may be selected after every ten products. Additionally, the actual algorithm used to define these intervals may be determined in any manner.

In the context of the current embodiment, it may be assumed that the products have been organized by price have further been divided into n intervals separated by the following n+1 points: 0, P₁, P₂, . . . , Pₙ. The next step may involve counting the number of occurrences of the feature within each price interval. A resulting histogram may define the distribution of the feature in terms of price. For example, a price range graph may be created for the feature.

For example, if a television with a 40 inch screen is more likely to occur at a price of 1000 dollars as opposed to 20000 dollars, the appropriate price may be associated with the screen size feature.

The mean and standard deviation (f_{avg}, f_{std}) of the feature are then computed based on the distribution. For example, the mean may be calculated by multiplying the frequency of the feature by the value of the product containing that feature in terms of price. This may be utilized to create a weighted value for the feature.

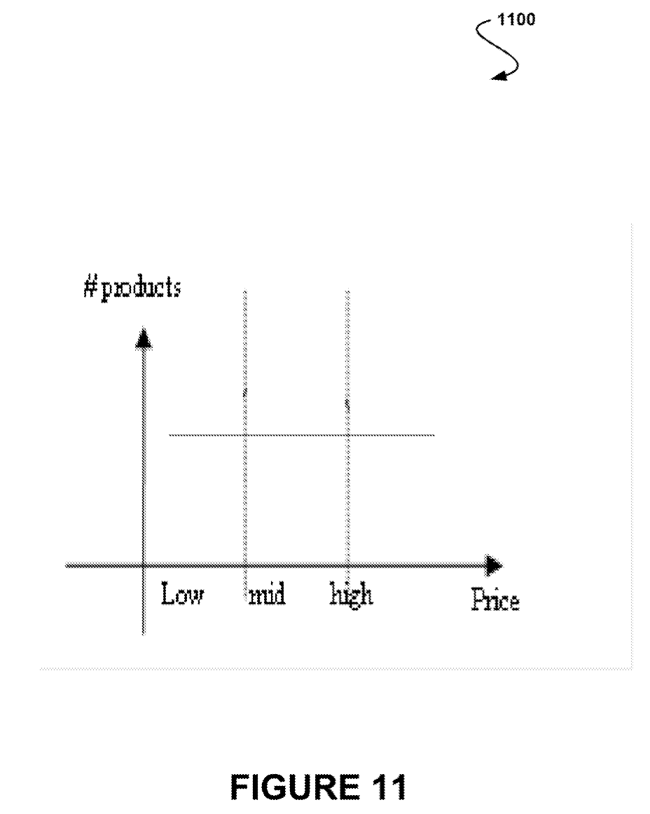

In one example, if the product is a television with a 40 inch screen, and the feature value to be calculated is for the screen size of the television, the price range graph for the 40 inch screen feature may be analyzed. If the mean price of products with a 40 inch screen is 1000 dollars, but the standard deviation is large, then the feature varies greatly between products. Therefore, the weight of the value given to the 40 inch screen feature may be reduced. An example of a graph 1100 of a feature with a large standard deviation is shown in FIG. 11. As shown, products in all price ranges have the feature.

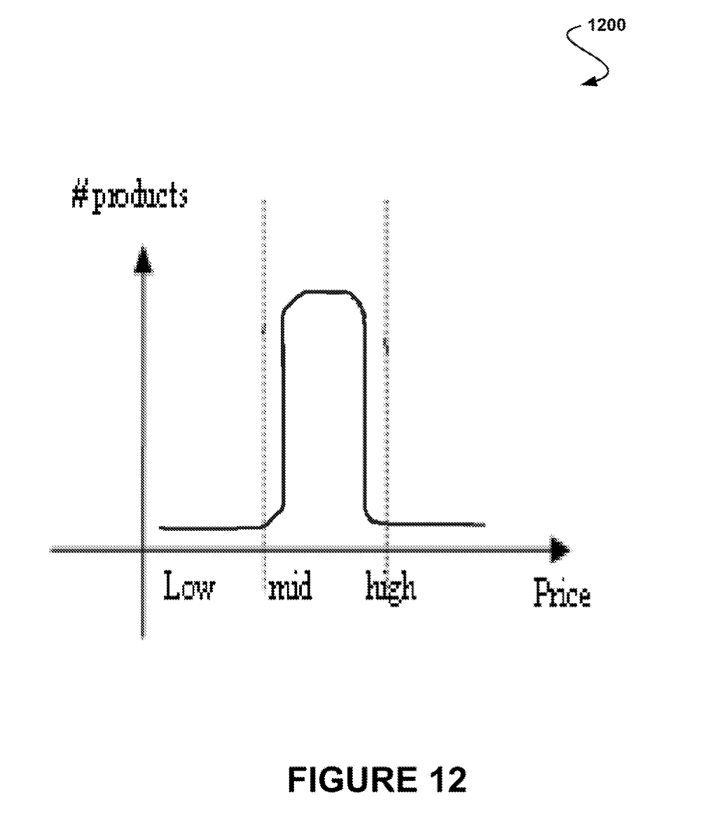

In another example, if the product is a television with a 50 inch screen, and the feature value to be calculated is for the screen size of the television, the price range distribution for the 50 inch screen feature may be analyzed. If the mean price of products with a 50 inch screen is 4000 dollars, but the standard deviation is small, then it is more likely that the value of the feature is consistent between products. Therefore, the weight of the value given to the 50 inch screen feature may be increased. An example of a graph 1200 for a feature with a small standard deviation is shown in FIG. 12.

In another embodiment, the value of the feature may be weighted based on the type of feature that is analyzed. For example, if a television contains a plasma flat panel display, and plasma displays are a known high quality component, then the value of the feature may be increased.

In this way, a score may be computed for the value of a feature, and may be used in the computation of the final feature value for a product.

Identifying Features From Numeric Attributes

The previous sub-section defines steps that may be used to compute the mean and standard deviation for the feature. In case of nominal attributes, ordinal attributes, and/or any other attributes having a finite set of fixed values, each different feature for the attribute may become an independent feature. For example, the maximum display format supported (1080 p, 720 p, etc.) for the product is a nominal attribute. In this case, 1080 p, 720 p, etc., may become individual features for the “Display Format Supported” attribute. In another embodiment, the attribute may include the screen size of the product (e.g., 20 inches, 25 inches, 30 inches, etc.). In another embodiment, the attribute may include a Boolean value. For example, the attribute may indicate whether the product has an LCD display. In one embodiment, it may be assumed that, in case of a nominal attribute, almost all products in a category will have one of the values already seen for the training products.

If the definition of a feature for a nominal attribute is extended to a real attribute, e.g., an attribute having real numbers as values, then an infinite number of features may result. Therefore, a mechanism is needed to convert the real values into a finite set of values. In other words, the real values may need to be converted into ordinal (finite, but ranked set) or nominal values. A set of rules may convert the real values into a small set of values. Examples of real attributes may include “Dimensions” (such as height, weight, width, length, etc.), “Resolutions,” “Focal Length,” etc. Once the real attribute is converted into a nominal or ordinal attribute, then the mean and standard deviation of its finite set of features (each nominal or ordinal value is a feature) may be computed, as defined above.

In another embodiment, a range of values may be grouped together to form a finite set of values. For example, the weight of a product may be organized as a finite set of values including the range of values of 10-12 pounds, 12-14 pounds, 14-17 pounds, 17-20 pounds, 21 or more pounds, etc. In another example, the screen size of a product may be organized as a finite set of values including the range of screen size values.

As a result, an individual set of value data may be obtained for each individual feature of the product.

Computation of a Final Feature Value for a Product

In one embodiment, a final feature value may be calculated for the product by summing all the individual feature values for the product. This sum may be weighted based on the standard deviation, mean, etc. for the individual feature values. As a result, a “low,” “mid,” or “high” rating for the product based on the feature values rates the product not just with respect to price, but also with respect to feature value.

For example, the final feature value for a product may be defined as a weighted sum of the mean (or other measures such as median, min, max, an arbitrary percentile, etc.) for the value of each individual feature that a product has. Note that entries for any real attributes may need to be converted into respective ordinal or nominal attributes. The final feature may be calculated, for example, using the equation shown in Table 1.

TABLE 1
F = Σwᵢ * f_{avg}_{_{—}}ᵢ

As shown in Table 1, wᵢ represents the weight for feature i and f_{avg}_{_{..}}ᵢ represents the mean for feature i. The weights may be based on the standard deviations of the features, may be manually defined, or may be statistically computed based on the ability of the feature to discriminate products (which may be determined utilizing a combination of the standard deviation and a spread of distribution). The final feature value, F, may define the price interval that a particular product belongs to based on all its features (e.g., where the product falls on a product snapshot in comparison to other products). This can be thought of as the facts-based value of a product as compared to a list of currently available products.

In another example, if a television with a resolution of 1080 i has a mean price of 1500 dollars, and a television with a screen size of 40 inches has a mean price of 1000 dollars, then a television with the features of a resolution of 1080 i and a screen size of 40 inches will have a value of (1500+1000)/2=1250 dollars. The feature values may be weighted for more accuracy.

Additionally, each product may then be plotted in terms of its computed facts-based price and its actual price in order to get the product snapshot. Additionally, LO, MID, and HI ranges may be determined based on the distribution of the products in the snapshot. For example, the ranges may be determined based on one or more gaps in the distribution of the products. As a result, the ranges may be based on the final feature value for all products.

Further Tailoring of Snapshot Computation

Missing Features

In one embodiment, products with missing attribute values may exist. This issue may occur both in training and in classifying a product. For example, a given feature may pull a product towards a particular value (e.g., a price interval). If a feature was absent during training and is later seen while classifying a new product, then this feature may be added to the training at a later stage. In one embodiment, new features may be flagged and incorporated into training in the next classification iteration.

In another example, a feature that is missed during training may be noticed during classification. This feature may be marked or flagged as not having been looked into during training. As a result, during the next training session, the feature may be added to the training set. As a result, the final feature value may be more accurately calculated.

In still another example, a new feature may be added to the product after training has occurred. This feature may be flagged and included in retraining. If the feature is only found in a few products, the weight of the feature may be lowered. However, as more products implement the feature, the weight of the feature may rise.

In another embodiment, a product may happen to have a missing attribute during classification. As a result, it may become difficult to compare the product to other products in the same category by using the snapshot. However, various embodiments of the present invention include a method to handle the occurrence of missing attributes during classification.

For example, the screen size of a flat panel television may not be available in the feature specifications retrieved from data from a partner source. In one embodiment this and other values may be automatically calculated and manually entered during classification. In another embodiment, an unavailable value may be estimated and manually entered during classification. For example, similar products to the particular product within the category may be determined by searching for features that the particular product is known to have. These similar products may be examined in order to estimate the values of any unavailable feature specifications.

Limited Entries for a Feature

In another embodiment, the training set may have very few entries for a given feature. As a result, the feature may disproportionately affect the final feature score. For example, the computed feature distribution may have a lower accuracy when very few entries exist. As a result, these attributes may need special handling.

This issue can be identified for ordinal attributes (e.g., attributes whose values are ranked in an order) a lower ranked attribute value is determined to have a higher mean feature value than a higher ranked attribute value. For example, an available training data set may yield a higher value for “Contrast” ratio value of “5000:1” than for “10000:1” due to only one high priced product having the value “5000:1”, whereas a number of lower priced products may have the “10000:1” value. In one embodiment, then use of manual overriding and/or computer generated values/estimates may be used to correct these features.

In another example, an available training data set may include a single product with a “10000:1” contrast ratio value. If it can be determined that a higher contrast ratio value is more desirable feature, a weight can be manually assigned to the feature, despite the fact that a single product has the feature. This manual assignment may be automatically recognized. A feature may be determined to be more desirable in a variety of ways. For example, if it is known that a “5000:1” contrast ratio value is preferred over a “2500:1.” contrast ratio value, which is in turn preferred over a “1000.1” contrast ratio value, and the single product with a “10000:1” contrast ratio value is encountered during classification, it may be determined based on the comparison of known ordering of preferences that the “10000:1” contrast ratio value is preferred over the “5000:1” contrast ratio value.

In another example, an inherent ordering may exist. For example, the ordering of a maximum resolution of products within a category may be inherent (e.g., “1080 p,” “720 p,” “480 p,” etc). In still another example, if an inherent ordering scheme cannot be automatically established, an order of features may be manually assigned.

Other Methods to Determine a Feature's Value

A number of other well-known mathematical techniques may be applied to approximate or optimally determine a feature's “inherent value.” For example, the values may be manually set to automatic estimation. For example, a feature's inherent value may be computed in terms of the product's price. In one embodiment, some other attribute may be selected instead of the price to compute the inherent value for a feature. Each product, prodᵢ consists of a list of features, f_{i,j}. Let the inherent value of a feature f be represented by I(f), Let pᵢ represent the price for the product, prodᵢ. Assuming that the features define a product's price, we can represent this by the equation illustrated in Table 2.

TABLE 2
ΣI(f_{i,j}) = pᵢ

In another embodiment, for a set of products in the training set with their prices known, the system of equations may be solved for each I(f_{i,j}). There are a number of optimization and approximation techniques that are developed for solving such a system of linear equations. An example would be Least Squares Approximation, Non-linear (polygonal Gaussian, quadratic) approaches may also be used to represent and solve such a system.

Other Methods to Determine a Feature's Value: “Baseline” Product Feature Level

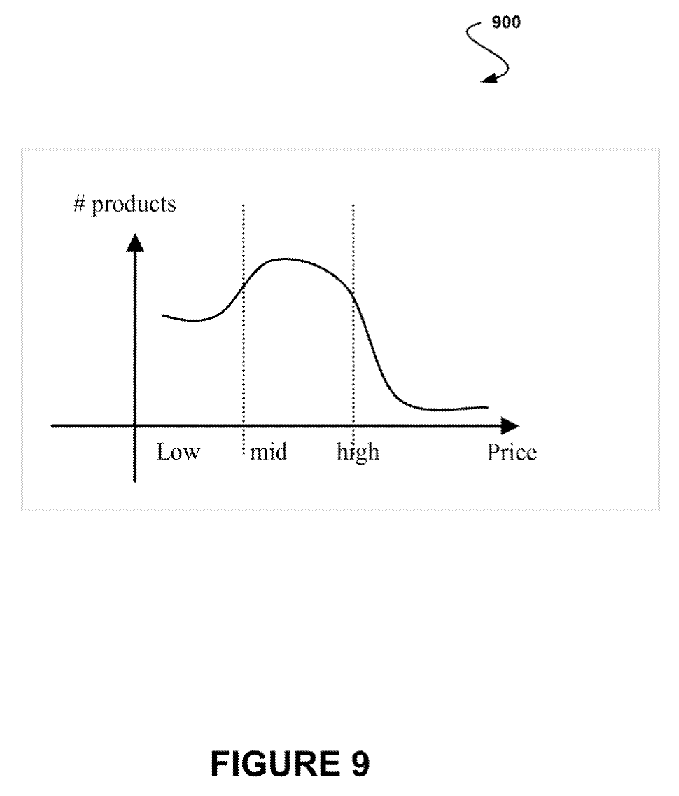

For example, a “baseline” feature level may be determined for one or more products. See graph 900 in FIG. 9. For example, all products that are predetermined to fall within a certain classification, e.g., of a certain type, having a specific feature, etc., may be determined, and a histogram may be plotted according to the prices of the products. For example, the graph 900 of FIG. 9 depicts a number of products having a specific feature vs. the price of the products. Additionally, the minimum, maximum, median, and standard deviation of the prices of the products may be calculated, and based on these values, the products may be divided into three sections: a low section 902, a mid section 904, and a high section 906.

Pricing is utilized in the current example to make the initial division because pricing may roughly determine the type of the product. For example, in the consumer's mind, “high-end” may be determined by the product's feature set, manufacturer brand, price, quality, buzz, and other factors. Market pricing may capture these factors. Therefore, using the pricing alone, the initial “training” set may be created for high, mid, and low end products.

Additionally, classification may be performed using each product's attribute values to create “baseline” feature vectors that differentiate the three sections. This creates a vector of product attributes and the probability of the attribute occurring in one of the low, mid, and high sections.

Using the “baseline” feature vectors and the initial price based section, each product may be classified into its “baseline” low, mid, high section. During this classification, some products that were inside one section based on the product price alone can migrate into another section based on a combination of price and features.

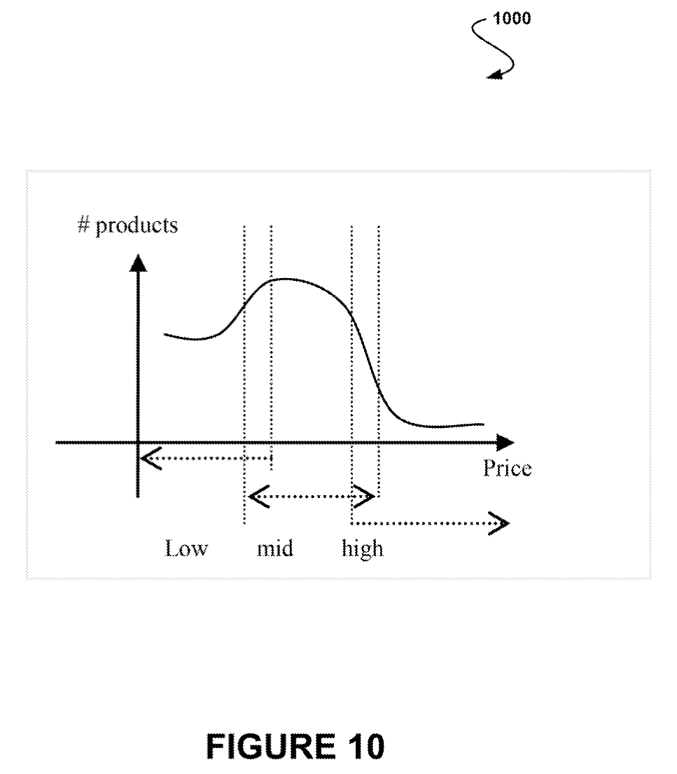

With the products classified into high, mid, and low categories, the prices within each type may be analyzed to produce average, median, high, and low prices for each product type. In one embodiment, some of the boundaries may overlap. An example of a “baseline” feature level graph with overlap is shown in FIG. 10.

Additionally, a set of product attributes may be established. Additionally, each attribute's affinity with a high, mid, and low product type may be determined. For example, it may be determined that “8 MP” is a common feature for a high-end product, but not for low-end product.

Other Methods to Determine a Feature's Value: “Real” Product Feature Level

In still another embodiment, once a product has been classified into its “baseline” feature level, the product's feature level may be adjusted in order to determine its “real” feature level. For example, the “real” feature level may be somewhere in a contiguous range from 0 to 1. This “real” feature level may then be used to characterize the product.

Additionally, the adjustment may be performed by giving each product an initial feature value according to which “baseline” feature level it is in. For example, if the “baseline” feature level of the product is “low”, then the starting feature value may be 0.15. In another example, if “baseline” feature level of the product is “mid”, then the starting feature value may be 0.5. In still another example, if the “baseline” feature level of the product is “high”, then the starting feature value may be “0.85”.

Furthermore, the feature value of the product may be increased if the product has features that are found in a higher “baseline” feature level. For example, a low-end product with a high-end feature will receive an increase in the feature value for its feature level. In yet another embodiment, the feature value of the product may be decreased if the product is missing a feature that is common in the feature level in which it is located.

As a result, the feature value obtained alter making the aforementioned adjustments may be the “real” feature level of a product. This “real” feature level may be higher or lower than the product's “baseline” feature level.

Other Methods to Determine a Feature's Value: Determining the Optimized Feature Level for a Single Product

In still another preferred embodiment, an optimal feature level computation may be used that is independent of the price ranges. For example, the basic steps in this process may include approximating the feature to price distribution for each individual feature, and then computing a single final feature value for the product based on its specified features. In this way, a better approximation to the actual feature to price distribution of all products in the category is relied on.

Interpreting the Feature-Price Chart

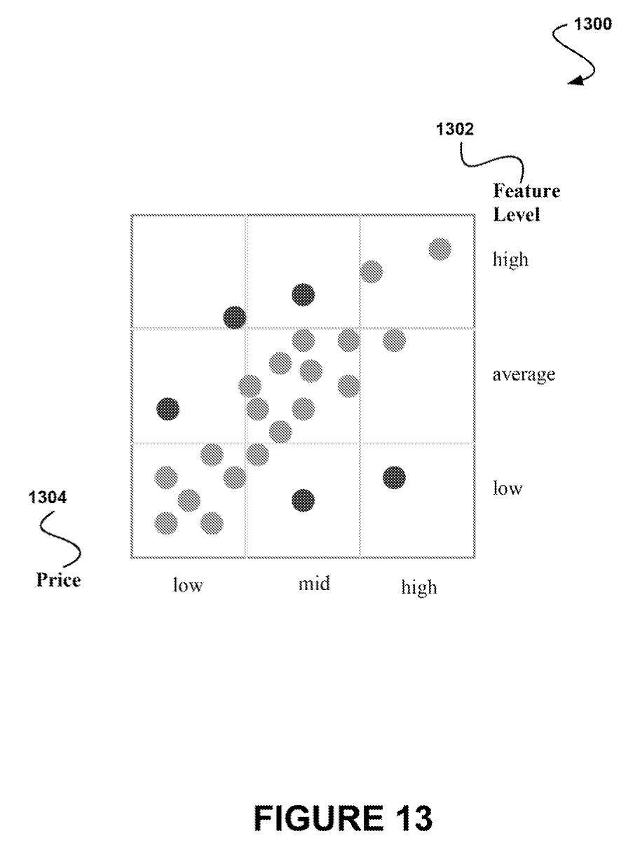

In still another embodiment, after the product's feature level has been adjusted in order to determine its “real” feature level, the products of the category may be displayed on a feature-price chart 1300, as shown in FIG. 13.

As shown, the feature-price chart 1300 includes a feature level indicator 1302, which indicates whether a particular product has a high, average, or low feature level. In addition, the feature-price chart 1300 includes a price indicator 1304 which indicates whether a particular product is low-priced, mid-priced, or high-priced.

In another embodiment, most of the products on the feature-price chart 1300 may be centered along the diagonal axis from (low feature, low price) to (high feature, high price). The diagonal axis may represent the probability of total feature value for a particular price point. Products within this area are the average low-end, mid-end, and high-end products. This is natural because the feature-level and the price-level are created based on the price. However, since each product is further adjusted using its individual features against the likely features of various feature levels, the products may appear scattered when plotted on the feature-price chart 1300.

Additionally, one or more products may occur outside of the diagonal axis. In one embodiment, if the product is located close to the axis, it may likely be a fair value. If the product is located at a higher point above the axis for a particular price range, it may be a better value within that price range.

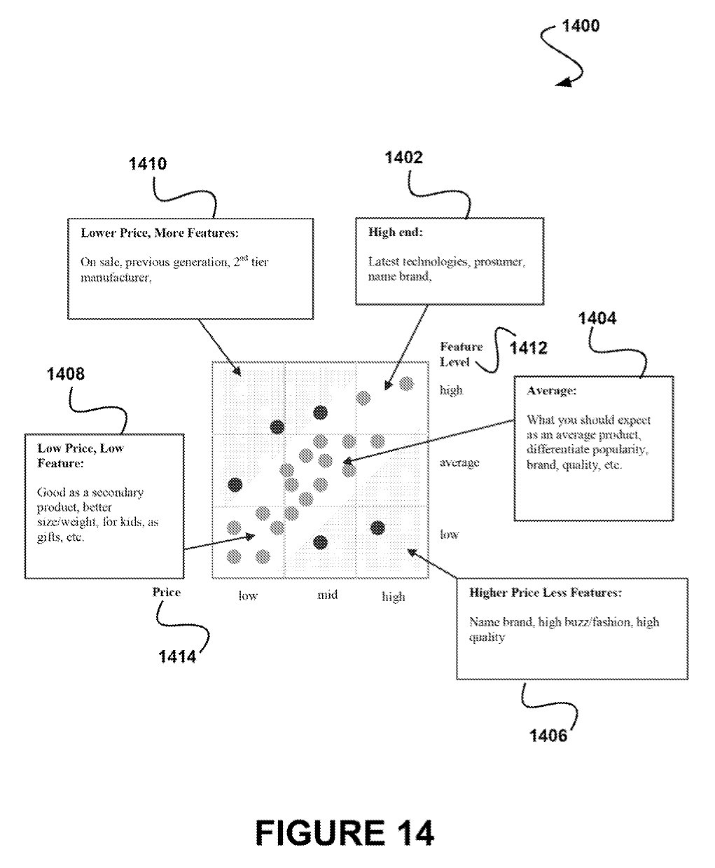

One analysis of the significance of product location on a feature-price chart is shown in FIG. 14. For example, if the product is located near location 1402, the product may include the latest technologies, may be a well known name brand, may be a professional consumer product, and/or may include any other characteristic considered to be “high-end.”

Further, if the product is located near location 1404, the product may include an average brand name, popularity, quality, and/or may include any other characteristic considered to be “average.” Further still, if the product is located near location 1406, the product may include a prominent brand name, high popularity and/or fashion, high quality, and/or may include any other characteristic considered to accompany a high priced product with fewer features when compared to the competition.

In addition, if the product is located near location 1408, the product may serve a purpose as a secondary product or a product for children, may be larger and/or heavier than the competition, may serve as a gift item, and/or may include any other characteristic considered to accompany a low priced product with a small amount of features when compared to the competition. Furthermore, if the product is located near location 1410, the product may be on sale, may be from a previous generation of products, may come from an unknown or second tier manufacturer, and/or may include any other characteristic considered to accompany a lower priced product with more features when compared to the competition.

In this way, it is possible to compare the features of each individual product against the features of other products within the low-end, mid-end, and high-end product sub-categories. For example, if the product contains more features than other products within a particular category, the product may fail above the diagonal axis within the category. In another example, if the product contains fewer features than other products within a particular category, the product may fall below the diagonal axis within the category. In still another example, if the product contains an average amount of features when compared to other products within a particular category, the product may fall close to the diagonal axis within the category.

It should be noted that any subset of data taken from the feature-price chart 1300 will still be organized relative to features, price, value, etc. Therefore, all products within the subset will be organized relative to each other. As a result, no additional computations are required for comparisons between products within the subset, which may provide a computational advantage and may prove beneficial in a real time presentation environment.

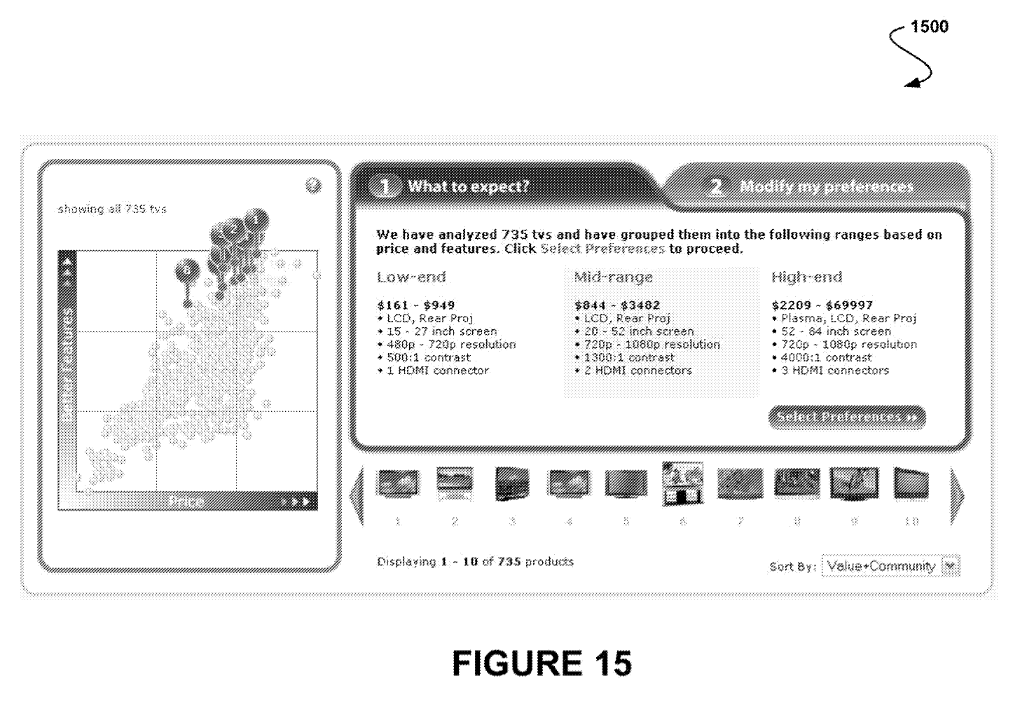

Additionally, a second display may accompany a feature-price chart. An example of such a display is found in display 1500 in FIG. 15. In one embodiment, the display 1500 may include a summary of the average features for one or more predetermined categories. For example, the display 1500 may include a summary of the average features for the low, mid, and high-end products shown on the feature-price chart 1300.

Additionally, the display 1500 may include one or more links to additional features available to the user. For example, the display 1500 may include a link to select further preferences in order to narrow search criteria and reduce the amount of products displayed on the feature-price chart 1300.

Further, in yet another embodiment, the display 1500 may include a summary of one or more products shown on the feature-price chart 1300. For example, the display 1500 may include a list of images representing products displayed on the feature-price chart 1300. In one embodiment, these products may be shown in more detail in a separate display.

In still another embodiment, the probability of the occurrence of various individual features for a particular product at a particular price point may be displayed. In this way, a standard may be set for what to expect for a particular product in the market today.

Presenting the Information

The visual representation of the products in relation to each other based on the value of the products in relation to each other may be output in any manner. For example, the visual representations may be presented on a plot of features vs. product price.

In another embodiment, for at least one of the products, data may be output which corresponds to an additional visual representation indicating whether the product has at least one of a larger feature set, a smaller feature set and a comparable feature set relative to the other products.

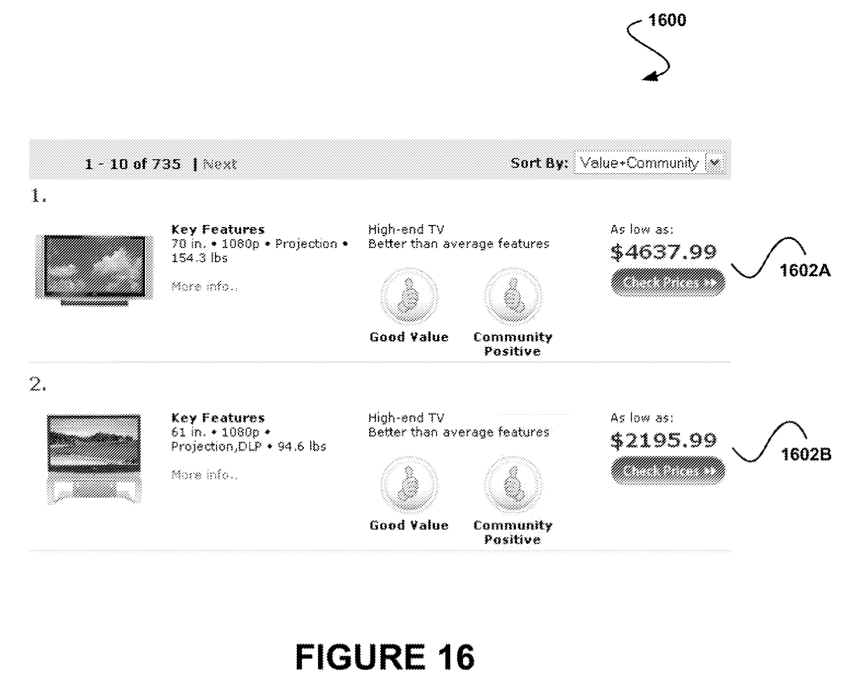

Further, when presenting the product facts box to the user, a simple description may be used in addition to a box diagram (for a box diagram example, see box diagram 800 of FIG. 8). The box diagram may serve the purpose of intriguing the user to look at one or more product facts. The description may explain the meaning of the box in simple terms. An example of a description including a simple list 1600 is shown in FIG. 16. As shown, the simple list 1600 contains information about 2 products.

The explanations 1602A-B for the illustrated products may be produced using one or more factors, including, but not limited to popularity, brand, quality, etc. To determine product popularity, the number of expert/user reviews may be counted. In another example, the brand can be editorially created. In still another example, quality may be obtained from other sources that performed a survey of product quality.

One goal of the explanations 1602A-B is not only to tell the user what the product is, but also to explain why a product has the certain undesirable characteristics such as “higher price” and “less features”. Possible explanations have been outlined in the previous section such as “better brand,” “very popular,” etc.

In one embodiment, the explanations 1602A-B may be automatically generated for every product based on an algorithm. This may be done by establishing a mapping between a characteristic of the product and elements of that characteristic. For example, the “high price” characteristic maybe mapped to elements such as “name brand,” “most popular,” “high fashion,” etc.

Additionally, each product may have its own table of mapped characteristics, as described above. An algorithm may then generate a text description for each characteristic using the product feature level and the description mapping.

In another embodiment, for at least one of the products, data may be output corresponding to an additional visual representation that indicates whether the product is at least one of a good value, a bad value and a comparable value relative to the other products. For example, the explanations 1602A-B may include one or more symbols to indicate the nature of one or more characteristics of the product or the overall product itself. The explanations 1602A-B may include a “thumbs up” to indicate a good value, a “thumbs down” to indicate a high price, a “sideways thumb” to indicate a fair price, etc.

In still another embodiment, the explanations 1602A-B may include one or more links to additional information. For example, the explanations 1602A-B may include a link to more information regarding the products displayed, a link to check available prices from one or more sellers of the products, etc.

In another embodiment, a ranking and/or a listing may be displayed for a particular category of products. In still another embodiment, products within the category may be listed based on a characteristic. For example, the top five televisions with 40 inch screens may be displayed in order of popularity. In another example, the top five televisions sold by a particular manufacturer may be displayed in order of value. Of course, however, any type of ranking and/or listing may be used.

In one embodiment, the ranking and/or listing may be accomplished by selecting a subset of a box diagram and ordering the products by particular criteria. For example, the value of the products may be organized by ranking the products by their distance from the diagonal axis of the box diagram.

In another embodiment, for at least one of the products, each of the products may be assigned to at least one group based on the price and feature set of the products, and data corresponding to a visual representation indicative of the grouping may be output. Such grouping may include separation of the products into such things as: high end, midrange, low end; best values overall, worst values overall; and may also take into account other factors such as market buzz (e.g., “what's hot”), etc. It should also be noted that products may fall into more than one grouping in some embodiments.

Other Uses

The product snapshot may be utilized for product research. In one embodiment, after one or more products are classified into locations on the snapshot box, one or more of the following views may be produced. Of course, however, any other views that can be created based on the products may be produced.

Show Most Popular Products

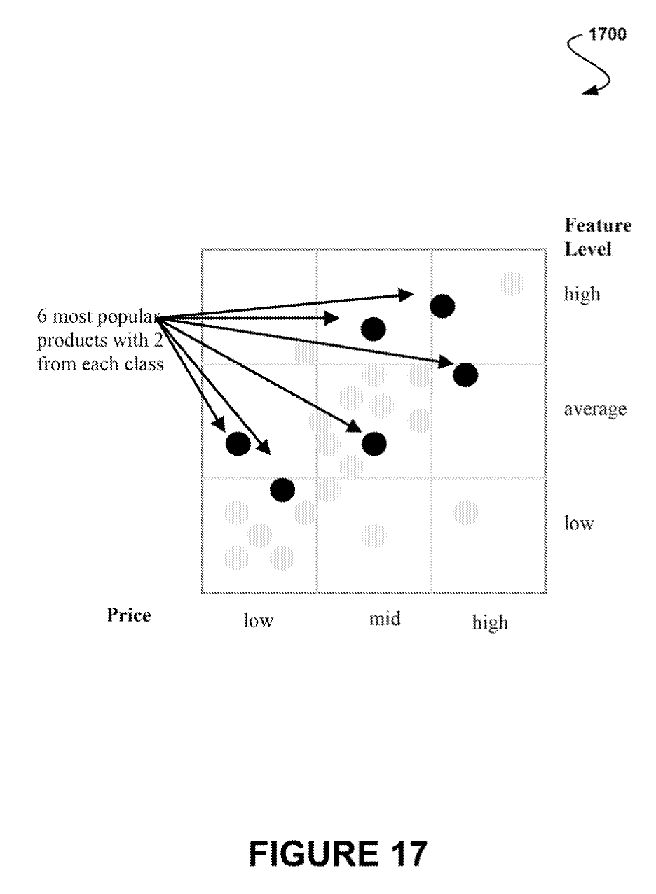

In one embodiment, the products for which data is output may be determined to be the most popular products in a larger set of products. In another embodiment, most popular products across several product classes may be highlighted. In yet another embodiment, a user interface may provide mouse over functionality which pops up product details when a mouse icon hovers over a particular product. In this way, a user may be given a quick comparison of where the most popular products are, or may be given a sense of the price feature differences between the most popular products. An example of this functionality is shown in a product snapshot 1700 in FIG. 17.

Manufacturer Type

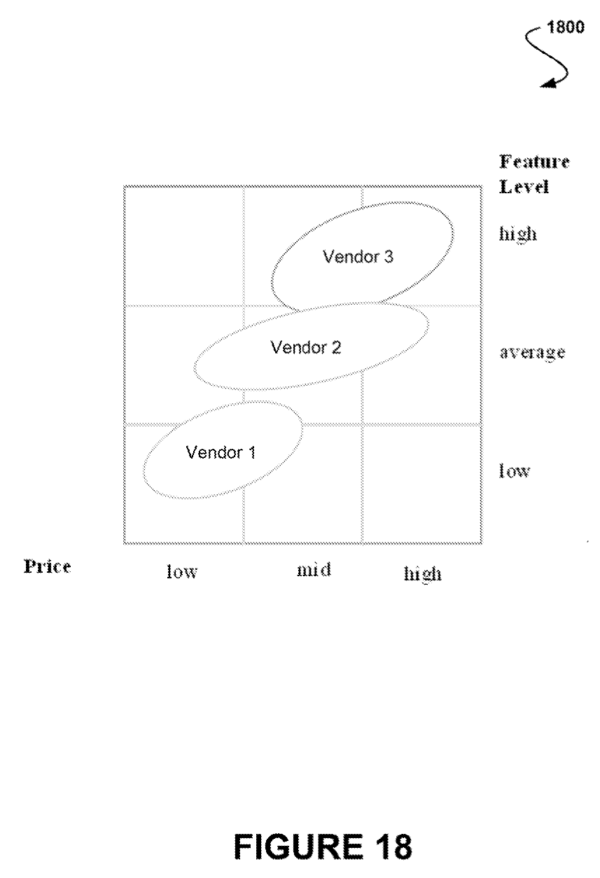

In another embodiment, the product snapshot may be utilized in order to show what kind of product a manufacturer makes. The kind of product may be organized from high end to low end. An example of this functionality is shown in a product snapshot manufacturer grouping 1800 in FIG. 18.

This product snapshot may help a consumer to choose a product by manufacturer by illustrating the kind of product the particular manufacturer makes, thereby saving the consumer independent research time.

In another embodiment, the product snapshot illustrating manufacturer type may be utilized for marketing. For example, the product snapshot may be used to assist in analyzing competitors.

Filter by Attributes

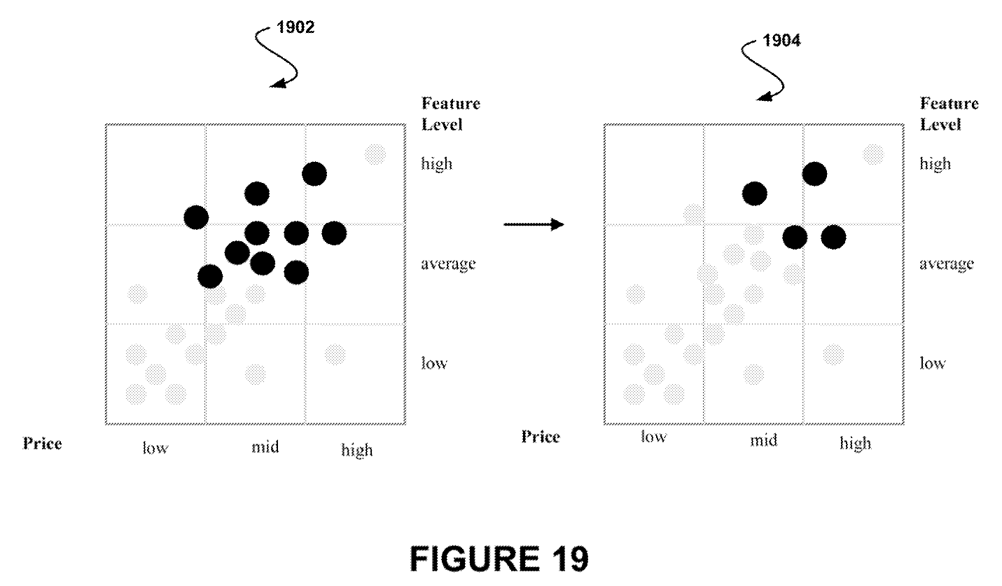

In yet another embodiment, when the product snapshot is combined with attribute filtering, the result of the filtering may be shown visually. For example, as shown in FIG. 19, suppose a graph 1902 illustrates a set of products matching particular criteria. If another condition is added (for example, the condition that the product contain “2 HDMI ports”), the graph 1902 is updated to a graph 1904, where only 4 products satisfy the new condition. In this way, a user searching for a product with one or more particular features, a particular price, etc. may narrow down the number of products available by those criteria.

Drill Down (or Focus Search)

In another embodiment, user input specifying a subset of the products may be received, and outputting data corresponding to a visual representation of the subset of products. In one embodiment, the subset of products may all contain a particular product attribute. In another embodiment, the user input may include selection of at least one of a price range, a feature set, and a manufacturer of the products.

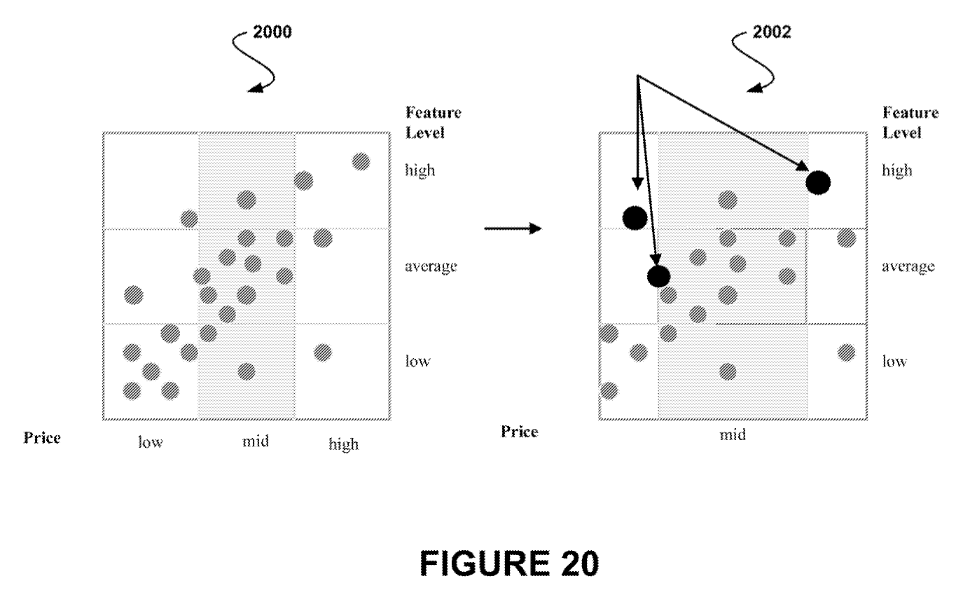

For example, once a user chooses to find the product with a price category or a feature category, the user may drill down using the snapshot diagram. As shown in FIG. 20, a user may choose to look at only the mid-priced product of a category using one of two varying displays. Therefore, in graph 2000, all “mid” priced products may be shown. Alternatively, however, graph 2002 may be shown, which displays the immediate “neighbors” of the “mid” priced products. In this way, the user may be made aware of products that are a bit more expensive, but have a lot more features, in addition to products that are a bit less expensive, but with a similar feature set.

In another embodiment, for at least one of the products, data corresponding to an additional visual representation listing a select number of the features of the product may be output. Further, in another embodiment, data corresponding to a link to additional information about the product may be output.

For example, the user may be able to focus on a particular region, product, etc. on the snapshot diagram. In still another embodiment, additional information may be made available from within the snapshot diagram. For example, a link to a manufacturer's product page may be made available when a particular product is chosen.

Additionally, in one embodiment, user input requesting output of information about at least one additional product having some user-selected relationship to one of products may be received. For example, products similar to a chosen product may be highlighted when the chosen product is selected (e.g., a square may form around all similar products on the snapshot diagram, etc.). Additionally, key attributes of the similar products may be displayed. In still another example, from a single product page, the user may select “show me better products”, “show me comparable products”, “show me products with a comparable feature set and lower price”, etc. As a result, products that are determined to be “better,” “similar,” “cheaper,” etc, may be determined and displayed.

Advanced Product Navigation

As shown above, the product snapshot diagram may be a way of navigating the product space. One advantage of this kind of navigation is that it is useful to go from all products to a set of fewer products in order to perform further detailed price or feature research. This is a unique approach comparing to the traditional directory hierarchy or attribute based search.

When used in navigation, each stage of the navigation may create criteria which narrow the number of products to be shown in the snapshot diagram. As a result, the snapshot diagram may provide an instant comparison of the products, which allows the user to select the next set of criteria.

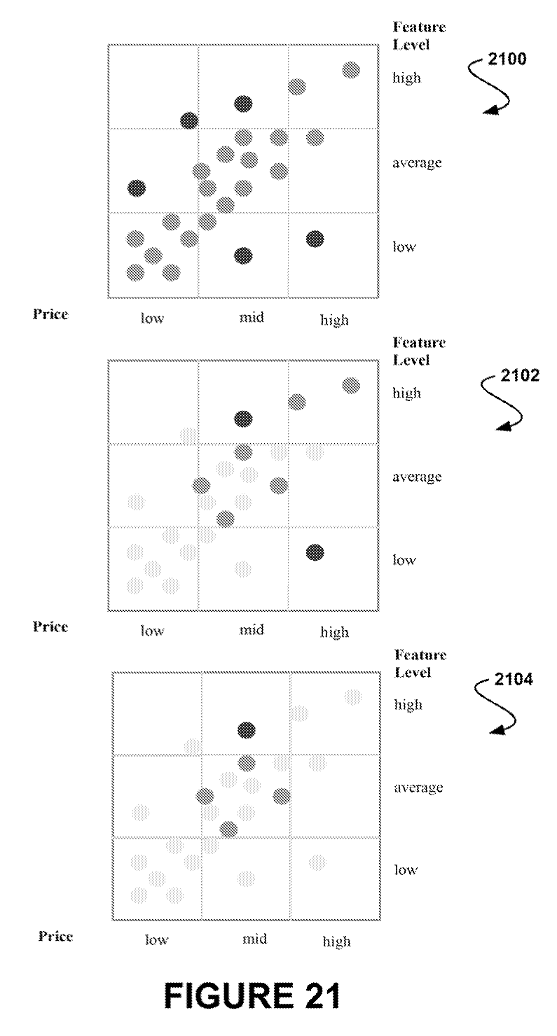

For example, as shown in FIG. 21, snapshot diagram 2100 displays all products within a particular category, with the most popular products highlighted. If the user wants to view only products from a particular manufacturer, the display may be refined, as illustrated in snapshot diagram 2102. If the user then wants to view only mid-priced products from the manufacturer, the display may be further refined, as illustrated in snapshot diagram 2104. The remaining displayed products may then be considered as purchase candidates. For example, the user may perform more detailed comparisons amongst the products with respect to price, feature, etc.

Attribute Subset Specific Snapshot

In still another embodiment, a product snapshot may be computed for a specific subset of product features in order to cater to specific market segments. For example, a total cost of ownership (TCO) snapshot may be based on a small subset of attributes such as type and frequency of replacement of consumables, content, accessories, etc.

Similarly, a GI (Green Index) snapshot may be computed from attributes such as energy efficiency, types of battery, recycling, rechargeability, wattage, etc. In the case of the GI snapshot, the Green Index may be computed independent of the price and plotted against the price. In another example, an energy value snapshot may be computed.

In addition to the above mentioned predefined attribute subset specific snapshots, dynamic snapshots may also be provided, in which the user can select the set of attributes they are interested in. Various products can then be compared through this snapshot based only on the features selected by the user. For example, the products within a certain category may be ranked only based on the attributes selected by the user.

Time Specific Snapshot

In yet another embodiment, one or more product snapshots may be monitored over a predetermined or infinite period of time. As a result of this monitoring, a series of graphs may be collected based on the time series of the product snapshots. This series of graphs may be analyzed in order to derive more information from the product snapshots.

For example, product snapshots may be monitored in order to determine how long a particular product has remained a best value within its category. This determination may in turn be illustrated in a time based product snapshot. In another example, a “bestseller list” may be determined for a particular category for a predetermined time period. In addition, time based product snapshots may be updated in real time.

The description herein is presented to enable any person skilled in the art to make and use the invention and is provided in the context of particular applications of the invention and their requirements. Various modifications to the disclosed embodiments will be readily apparent to those skilled in the art and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

In particular, various embodiments of the invention discussed herein are implemented using the Internet as a means of communicating among a plurality of computer systems. One skilled in the art will recognize that the present invention is not limited to the use of the Internet as a communication medium and that alternative methods of the invention may accommodate the use of a private intranet, a Local Area Network (LAN), a Wide Area Network (WAN) or other means of communication. In addition, various combinations of wired, wireless (e.g., radio frequency) and optical communication links may be utilized.

The program environment in which one embodiment of the invention may be executed illustratively incorporates one or more general-purpose computers or special-purpose devices such hand-held computers. Details of such devices (e.g., processor, memory, data storage, input and output devices) are well known and are omitted for the sake of clarity.

It should also be understood that the techniques of the present invention might be implemented using a variety of technologies. For example, the methods described herein may be implemented in software running on a computer system, or implemented in hardware utilizing either a combination of microprocessors or other specially designed application specific integrated circuits, programmable logic devices, or various combinations thereof. In particular, methods described herein may be implemented by a series of computer-executable instructions residing on a storage medium such as a carrier wave, disk drive, or computer-readable medium. Exemplary forms of carrier waves may be electrical, electromagnetic or optical signals conveying digital data streams along a local network or a publicly accessible network such as the Internet. In addition, although specific embodiments of the invention may employ object-oriented software programming concepts, the invention is not so limited and is easily adapted to employ other forms of directing the operation of a computer.

The invention can also be provided in the form of a computer program product comprising a computer readable medium having computer code thereon. A computer readable medium can include any medium capable of storing computer code thereon for use by a computer, including optical media such as read only and writeable CD and DVD, magnetic memory, semiconductor memory (e.g., FLASH memory and other portable memory cards, etc.), etc. Further, such software can be downloadable or otherwise transferable front one computing device to another via network, wireless link, nonvolatile memory device, etc.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for generating value-based information, comprising:
under control of a computer:
generating statistical data for particular features of a plurality of products based on prices of the products;
generating a base score for each of the features based on the statistical data;
for each of at least some of the products, computing a product feature score for the product based on the base scores of the features that the product has; and
outputting, for the at least some of the products, a representation of a value of each of the at least some of the products in relation to each other, the representation of the value being based on the product feature score and the price for each of the products.

2. A method as recited in claim 1, wherein the representations of the values of each of the at least some of the products in relation to each other are plotted on a chart of price vs. features.

3. A method as recited in claim 1, wherein generating the statistical data includes, for a particular product feature, associating each of the products with at least one of a plurality of price bins based on an actual price of the product; and, for each price bin, determining a number of products having the particular product feature.

4. A method as recited in claim 1, wherein generating the statistical data includes, for a particular product feature, selecting a plurality of price bins; and, for each price bin, determining a number of products in each price bin having the particular product feature.

5. A method as recited in claim 4, wherein computing the product feature score for a particular one of the products includes summing the base scores of the features that the particular product has.

6. A method as recited in claim 5, wherein each of the base scores is given a weighting prior to the summing.

7. A method as recited in claim 6, wherein the weighting is based on at least one of a standard deviation of a feature to price distribution for each of the features of the products, a manually-defined value, and a statistically computed value based at least in part on prices of the products.

8. A method for displaying product information, comprising:
approximating a feature to price distribution for each of a plurality of features of a plurality of products;
computing a product feature score for each of at least a subset of the products; and
outputting data corresponding to a visual representation of the at least a subset of the products in relation to each other based on the product feature scores and prices of each of the at least a subset of the products.

9. A method as recited in claim 8, wherein the approximating the feature to price distribution includes, for a particular product feature, associating each of the products with at least one of a plurality of price bins based on an actual price of the product; and, for each price bin, determining a number of products having the particular product feature.

10. A method as recited in claim 8, wherein the approximating the feature to price distribution includes, for a particular product feature, selecting a plurality of price bins; and, for each price bin, determining a number of products in each price bin having the particular product feature.

11. A method as recited in claim 10, wherein computing the product feature score for a particular one of the products includes summing statistical derivatives of the feature to price distributions of the features of the particular product.

12. A method as recited in claim 11, wherein each of the statistical derivatives is given a weighting.

13. A method as recited in claim 12, wherein the weighting is based on at least one of a standard deviation of the feature to price distribution, a manually-defined value, and a statistically computed value.

14. A method for displaying product information, comprising:
assigning a value to each of a plurality of features of a plurality of products;
computing a product feature score for each of at least a subset of the products; and
outputting data corresponding to a visual representation of the at least a subset of the products in relation to each other based on the product feature scores and prices of each of the at least a subset of the products.

15. A method for displaying product information, comprising:
determining a value of each of a plurality of products relative to the other products, the values being based on features and prices of the products; and
outputting data corresponding to a visual representation of the products in relation to each other based on the value of the products in relation to each other.

16. A method as recited in claim 15, wherein the visual representations are presented on a plot of features vs. product price.

17. A method as recited in claim 15, further comprising, for at least one of the products, outputting data corresponding to an additional visual representation indicating whether the product is at least one of a good value, a bad value and a comparable value relative to the other products.

18. A method as recited in claim 15, further comprising, for at least one of the products, outputting data corresponding to an additional visual representation indicating whether the product has at least one of a larger feature set, a smaller feature set and a comparable feature set relative to the other products.

19. A method as recited in claim 15, further comprising receiving user input specifying a subset of the products, and outputting data corresponding to a visual representation of the subset of products.

20. A method as recited in claim 19, wherein the user input includes selection of at least one of a price range, a feature set, and a manufacturer of the products.

21. A method as recited in claim 15, further comprising, for at least one of the products, outputting data corresponding to an additional visual representation listing a select number of the features of the product, and outputting data corresponding to a link to additional information about the product.

22. A method as recited in claim 15, further comprising receiving user input requesting output of information about at least one additional product having some user-selected relationship to one of products.

23. A method as recited in claim 15, wherein the products for which data is output are determined to be the most popular products in a larger set of products.

24. A method as recited in claim 15, wherein a subset of the visual representations are highlighted based on defined criteria.

25. A method as recited in claim 15, further comprising, for at least one of the products, assigning each of the products to at least one group based on the price and feature set of the products, and outputting data corresponding to a visual representation indicative of the grouping.

26. A method for outputting a comparison of products based on a value of the products, comprising:
under control of a computer:
determining a value of each of a plurality of products relative to the other products, the values being based on features and prices of the products;
outputting data corresponding to a visual representation of the products in relation to each other on a plot of features vs. product price based on the value of the products in relation to each other;
receiving user input specifying a subset of the products, and outputting data corresponding to a visual representation of the subset of products; and
for at least one of the products, outputting data corresponding to an additional visual representation listing a select number of the features of the product, and outputting data corresponding to a link to additional information about the product,
wherein a subset of the visual representations are highlighted based on defined criteria.
